(19) United States
(12) Patent Application Publication
(10) Pub. No.: US 2019/0218374 A1
(43) Pub. Date: Jul. 18, 2019

(54) COMPOSITE MADE OF A METAL COMPONENT AND A FUNCTIONAL POLYMER MATRIX

(71) Applicant: COMPAGNIE GENERALE DES ETABLISSEMENTS MICHELIN, Clermont-Ferrand (FR)

(72) Inventors: Odile GAVARD-LONCHAY, Clermont-Ferrand Cedex 9 (FR); Anne-Lise THUILLIEZ, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/333,741

(22) PCT Filed: Sep. 14, 2017
(86) PCT No.: PCT/FR2017/052455

§ 371 Date: Mar. 15, 2019

(30) Foreign Application Priority Data
Sep. 16, 2016 (FR) 16/58702

(51) Int. Cl. C08L 7/00; B60C 9/00; B60C 1/00

(52) U.S. Cl. CPC C08L 7/00; C08L 2312/02; B60C 1/00; B60C 9/005

(57) ABSTRACT

A composite based at least on a component having a metallic surface and on a polymer matrix comprising a diene elastomer DE and a functional diene polymer is provided. The functional diene polymer is a diene polymer bearing at least one functional group, the functional group being the phosphonic acid functional group, the phosphonic hemiacid functional group, the phosphonic acid diester functional group or a salt of the phosphonic acid or phosphonic hemiacid functional group. Such a composite exhibits good resistance to tearing-out.

This application is a 371 national phase entry of PCT/FR2017/052455 filed on 14 Sep. 2017, which claims benefit of French Patent Application No. 16/58702, filed 16 Sep. 2016, the entire contents of which are incorporated herein by reference for all purposes.

### BACKGROUND

### 1. Technical Field

The present invention relates to the field of composites based on metal and on diene polymer intended to be used, for example, as reinforcing structure or reinforcement in tires for vehicles, in particular with radial carcass reinforcement, such as carcass plies or crown plies.

### 2. Related Art

In a known way, a tire with radial carcass reinforcement comprises a tread, two inextensible beads, two sidewalls connecting the beads to the tread and a belt positioned circumferentially between the carcass reinforcement and the tread, this belt and the carcass reinforcement consisting of various plies (or “layers”) of rubber reinforced with threadlike reinforcing elements or threadlike reinforcers, such as cords or monofilaments, for example made of metal. A reinforcing ply reinforced with threadlike elements is thus formed of a rubber and of reinforcing elements which are embedded in the rubber. The rubber is generally based on a diene elastomer, such as natural rubber, on a reinforcing filler, such as carbon black, on a crosslinking system based on sulfur and on zinc oxide. The reinforcement elements are positioned virtually parallel to one another inside the ply.

In order to effectively fulfil their function of reinforcing these plies, which are subjected, as is known, to very high stresses during running of the tires, the threadlike metal reinforcing elements must satisfy a very large number of sometimes contradictory technical criteria, such as high fatigue endurance, high tensile strength, high wear resistance, high corrosion resistance and strong adhesion to the surrounding rubber, and be capable of maintaining these performance qualities at a very high level for as long as possible.

It is easily understood that the adhesion between the rubber and the threadlike metal reinforcing elements is thus a key property in the durability of these performance qualities. For example, the conventional process for connecting the rubber to steel consists in coating the surface of the steel with brass (copper-zinc alloy), the bond between the steel and the rubber being provided by sulfurization of the brass during the vulcanization or curing of the elastomer present in the rubber. In point of fact, it is known that the adhesion between the steel and the rubber is capable of weakening over time as a result of the gradual development of sulfides formed under the effect of the various stresses encountered, in particular mechanical and/or thermal stresses.

It is thus an ongoing concern of tire manufacturers to find composites based on metal and on a diene polymer matrix which are alternative solutions to the pre-existing composites and which are cohesive without it being necessary to resort to a sulfurization stage.

### SUMMARY

During their research studies, the Applicant Companies have discovered a solution which makes it possible to solve the problems mentioned for different metals.

Thus, a first subject-matter of the invention is a composite based at least on a component having a metallic surface and on a polymer matrix comprising a diene elastomer DE and a functional diene polymer, which functional diene polymer is a diene polymer bearing at least one functional group, the functional group being the phosphonic acid functional group, the phosphonic hemiacid functional group, the phosphonic acid diester functional group or a salt of the phosphonic acid or phosphonic hemiacid functional group.

The invention also relates to a tire comprising the composite in accordance with the invention.

### I. DETAILED DESCRIPTION OF EXAMPLE EMBODIMENTS

In the present description, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

In the present description, unless expressly indicated otherwise, all the percentages (%) shown are % by weight. The contents of the compounds expressed in parts are parts by weight.

The expression composite “based at least on a component and on a polymer matrix” should be understood as meaning a composite comprising the component and the polymer matrix, the polymer matrix having been able to react with the metallic surface of the component during the various phases of manufacture of the composite, in particular during the crosslinking of the polymer matrix or during the preparation of the composite before crosslinking of the polymer matrix.

The compounds mentioned and participating in the preparation of rubber compositions can be of fossil or biobased origin. In the latter case, they may partially or completely result from biomass or be obtained from renewable starting materials resulting from biomass. Polymers, plasticizers, fillers, and the like, are concerned in particular.

In the present patent application, the designations “the phosphonic acid functional group”, “the phosphonic hemiacid functional group” and “the phosphonic acid diester functional group” respectively denote the P(O)(OH)₂, P(O)(OH)(OR) and P(O)(OR)₂ functional groups, R, which are identical or different, being a hydrocarbon group which can be substituted or interrupted by one or more heteroatoms.

In the present patent application, the word (meth)acrylate denotes without distinction acrylate or methacrylate.

The composite in accordance with the invention is based at least on a polymer matrix and on a component which exhibits a metallic surface, that is to say a surface made of metal. The polymer matrix represents all of the polymers (that is to say, macromolecular chains) present in the composite. The metallic surface of the component can be all or part of the total surface of the component and is intended to come into contact with the polymer matrix, that is to say to come into contact with one or more polymers of the polymer matrix.

According to the invention, the component is completely or partially coated with the polymer matrix.

According to the invention, only a portion of the component is metallic, this portion being at least formed of the metallic surface, or else it is the whole of the component which is metallic. Preferably, the component is entirely made of metal.

According to a first alternative form of the invention, the metallic surface of the component is made of a material which is different from the remainder of the component. In other words, the component is made of a material which is completely or partially covered with a metal layer which forms the metallic surface. The material completely or partially covered with the metallic surface is metallic or non-metallic, preferably metallic, in nature.

According to a second alternative form of the invention, the component is made of one and the same material, in which case the component is made of a metal which is identical to the metal of the metallic surface.

According to an advantageous embodiment of the invention, the metallic surface comprises iron, copper, zinc, tin, aluminium, cobalt or nickel.

According to a particularly preferred embodiment of the invention, the metal of the metallic surface is a metal selected from the group consisting of iron, copper, zinc, tin, aluminium, cobalt, nickel and alloys comprising at least one of these metals. The alloys can, for example, be binary or ternary alloys, such as steel, bronze and brass. Preferably, the metal of the metallic surface is iron, copper, tin, zinc or an alloy comprising at least one of these metals. More preferably, the metal of the metallic surface is steel, brass (Cu—Zn alloy) or bronze (Cu—Sn alloy).

In the present patent application, the expression “the metal of the metallic surface is the metal denoted hereinafter” amounts to saying that the metallic surface is made of metal denoted hereinafter. For example, the expression “the metal of the metallic surface is iron” written above means that the metallic surface is made of iron.

When the metallic surface is made of steel, the steel is preferably a carbon steel or a stainless steel. When the steel is a carbon steel, its carbon content is preferably between 0.01% and 1.2% or between 0.05% and 1.2%, or else between 0.2% and 1.2%, in particular between 0.4% and 1.1%. When the steel is stainless, it preferably comprises at least 11% of chromium and at least 50% of iron.

The component can be of any shape. Preferably, the component is provided in the form of a thread or of a cord.

According to a specific embodiment of the invention, the component exhibits a length which is at least equal to a millimetre. Length is understood to mean the greatest dimension of the component. Mention may be made, as component having a length which is at least equal to a millimetre, of the reinforcing elements for example used in vehicle tires, such as threadlike elements (monofilament or cord) and non-threadlike elements.

According to a particularly preferred embodiment of the invention, the composite is a reinforced structure in which the component constitutes a reinforcing element and in which the polymer matrix coats the reinforcing element.

The polymer matrix has the essential characteristic of comprising a functional diene polymer defined as a diene polymer which bears at least one functional group, that is to say one or more functional groups, the functional group being the phosphonic acid functional group, the phosphonic hemiacid functional group, the phosphonic acid diester functional group or a salt of the phosphonic acid or phosphonic hemiacid functional group. The functional diene polymer can be an elastomeric polymer or a liquid polymer. According to any one of the embodiments of the invention, the diene polymer of use for the requirements of the invention preferably exhibits a number-average molar mass of less than 50 000, in particular of between 1000 and 50 000.

According to a specific embodiment of the invention, the functional diene polymer bears several of said functional groups.

The reader is reminded that diene polymer should be understood as meaning a polymer which comprises diene units and which generally results, at least in part (i.e. a homopolymer or a copolymer), from diene monomers (monomers bearing two conjugated or non-conjugated carbon-carbon double bonds).

More particularly, diene polymer is understood to mean any homopolymer of a conjugated diene monomer, any copolymer of a conjugated diene monomer or a mixture thereof, the conjugated diene monomer having from 4 to 12 carbon atoms.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene or 2,4-hexadiene.

Preferably, the functional diene polymer is selected from the group of polymers consisting of polybutadienes, polyisoprenes, 1,3-butadiene copolymers, isoprene copolymers and mixtures thereof. Mention may very particularly be made, as 1,3-butadiene or isoprene copolymers, of those resulting from the copolymerization of 1,3-butadiene or isoprene with styrene or a (meth)acrylate. A person skilled in the art clearly understands that the polybutadienes, the polyisoprenes, the 1,3-butadiene copolymers or the isoprene copolymers as functional diene polymer of use for the requirements of the invention bear one or more functional groups as defined above.

According to any one of the embodiments of the invention, the diene units in the functional diene polymer preferably represent more than 50%, more preferably more than 70%, by weight of the functional diene polymer.

According to any one of the embodiments of the invention, the functional group is preferably a pendent group of the polymer chain of the functional diene polymer.

The functional group can be at the end of the polymer chain of the functional diene polymer or outside the ends of the polymer chain of the functional diene polymer. When it is outside the ends of the polymer chain of the functional diene polymer, it is pendent.

According to a specific embodiment of the invention, the functional group is borne exclusively at the chain end of the polymer chain of the functional diene polymer, in particular on just one end or on each end of the polymer chain of the functional diene polymer.

The functional diene polymer can be synthesized by methods known to a person skilled in the art. For example, mention may be made, in a non-limiting way, of:
the radical copolymerization of a 1,3-diene and of a (meth)acrylate bearing the functional group of use for the requirements of the invention as described in Patent Application WO 2016079411, it being possible for the copolymerization to be followed by a reaction for partial or complete hydrolysis of the functional group;
the radical copolymerization of a 1,3-diene and of a vinylphosphonate as described in the document J. Polym. Sc., 1952, 8, 255-256, or Patent Application FR 1 403 732;
the modification of diene polymers by phosphorylation or by radical addition of a thiol bearing the functional group as described in the documents Adv. Synth. Cat., 2008, 350(3), 431-438, and Polym. Bull., 1998, 41, 145-151, respectively;
the modification of diene polymers bearing a nucleophilic group at the chain end by a compound simultaneously bearing the functional group and bearing an electrophilic group as described, for example, in the patent application filed under number FR15/62885.

The method of preparation of the functional diene polymer is judiciously chosen by a person skilled in the art according to whether the functional group is at the chain end of the functional diene polymer or outside its chain ends, according to the macrostructure of the functional diene polymer, in particular the value of its number-average molar mass and of its polydispersity index, according to the microstructure of the functional diene polymer, in particular respective contents of 1,4-cis, 1,4-trans and 1,2 bonds of the diene portion of the functional diene polymer, and according to whether the functional group is the phosphonic acid, phosphonic hemiacid or phosphonic acid diester functional group or a salt of the phosphonic acid or phosphonic hemiacid functional group.

Preferably, the functional group is the phosphonic acid functional group, the phosphonic hemiacid functional group or one of their salts.

According to any one of the embodiments of the invention, the R radical of the functional group is preferably an alkyl, more preferably an alkyl comprising from 1 to 3 carbon atoms, more preferably still a methyl.

The content of functional group in the functional diene polymer preferably varies from 0.01 to 3 milliequivalents per g (meq/g), more preferably from 0.15 to 2 meq/g, of functional diene polymer. These ranges of contents can apply to any one of the embodiments of the invention.

According to a specific embodiment of the invention, the functional diene polymer represents at most 30% by weight of the polymer matrix, preferably from 5% to less than 30% by weight of the polymer matrix.

The polymer matrix comprises, in addition to the functional diene polymer, a diene elastomer, DE, which preferably represents at least 70% by weight of the polymer matrix. A diene elastomer is understood to mean one or more diene elastomers which differ from one another in their microstructure or their macrostructure.

Diene elastomer (or alternatively “rubber”, where the two terms are considered to be synonymous) must be understood in the known manner as a diene polymer as defined above in terms of its microstructure.

Diene elastomers can be classified into two categories: “essentially unsaturated” or “essentially saturated”. The term “essentially unsaturated” generally refers to a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be described as “essentially saturated” diene elastomers (low or very low content, always less than 15%, of units of diene origin). In the category of “essentially unsaturated” diene elastomers, a “highly unsaturated” diene elastomer is understood in particular to mean a diene elastomer having a content of units of diene origin (conjugated dienes) which is greater than 50%.

The diene elastomer DE can be star-branched, coupled, functionalized or non-functionalized, in a way known per se, by means of functionalization agents, coupling agents or star-branching agents known to a person skilled in the art.

The diene elastomer DE is preferably a highly unsaturated diene elastomer, in the most preferred manner selected from the group of highly unsaturated elastomers constituted of polybutadienes, polyisoprenes, 1,3-butadiene copolymers, isoprene copolymers and mixtures thereof. In an even more preferred manner, the diene elastomer DE is a polyisoprene with more than 90% by weight of 1,4-cis bonding. Better, the diene elastomer is natural rubber.

According to one particular embodiment of the invention, the diene elastomer DE and the functional diene polymer represent at least 90% by weight of the polymer matrix. This embodiment is advantageous in particular for a tire application for obtaining good resistance to tearing-out of the composite while at the same time benefitting from the properties intrinsic to the diene elastomer DE, such as its properties of elasticity, cohesion, crystallization under tension as in the case of natural rubber. The polymer matrix preferably consists of the functional diene polymer and the diene elastomer DE, which makes it possible to obtain the best comprise between the adhesion properties and the other properties, in particular mechanical properties, of the rubber composition. This particular embodiment, and also its preferential version, can be combined with any one of the other embodiments of the invention.

The composite in accordance with the invention may comprise a reinforcing filler distributed in the polymer matrix.

The reinforcing filler is generally used to improve for example cohesion or rigidity of the polymer matrix. The reinforcing filler is a filler known for its ability to reinforce a polymer matrix containing a diene polymer, more particularly an elastomer. The reinforcing filler is typically a reinforcing filler conventionally used in rubber compositions that can be used for the manufacture of tires. The reinforcing filler is, for example, an organic filler such as carbon black, an inorganic reinforcing filler such as silica, with which a coupling agent is combined in a known manner, or else a mixture of these two types of filler. The reinforcing filler is preferably carbon black.

Such a reinforcing filler typically consists of nanoparticles, the (weight-) average size of which is less than a micrometre, generally less than 500 nm, most commonly between 20 and 200 nm, in particular and more preferentially between 20 and 150 nm.

All carbon blacks, especially the blacks conventionally used in tires or their treads (“tire-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used.

The reinforcing filler content is selected by a person skilled in the art depending on the application envisaged for the composite and on the nature of the reinforcing filler, in particular the value of its BET specific surface area. For example, for an application of the composite in the tire, in particular as a reinforcing structure or reinforcement in the tire, the reinforcing filler content is preferably within a range extending from 20 parts to 80 parts per 100 parts of polymer matrix. Below 20 parts, the reinforcement of the polymer matrix may be insufficient. Above 80 parts, there is a risk of increased hysteresis of the polymer matrix that may cause the composite to heat, which may lead to performance degradation in the composite.

The composite in accordance with the invention may comprise a system for crosslinking the polymer matrix. During manufacturing of the composite, the crosslinking system is intended to react to cause crosslinking of the polymer matrix, generally after the component is brought into contact with the polymer matrix containing the crosslinking system and optionally the reinforcing filler and after its shaping. The crosslinking generally improves the elastic properties of the polymer matrix. The crosslinking system can be a vulcanization system or be based on one or more peroxide compounds, for example conventionally used in rubber compositions that can be used for the manufacture of tires.

The vulcanization system proper is based on sulfur (or on a sulfur-donating agent) and generally on a primary vulcanization accelerator. Various known secondary vulcanization accelerators or vulcanization activators, such as zinc oxide, stearic acid or equivalent compounds, or guanidine derivatives (in particular diphenylguanidine), may be added to this base vulcanization system, for example being incorporated during the first non-productive phase and/or during the productive phase, as described subsequently. Sulfur is used at a preferential content ranging from 0.5 to 12 parts per hundred, in particular from 1 to 10 parts per hundred parts of the polymer matrix. The primary vulcanization accelerator is used at a preferential content of between 0.5 and 10 parts per hundred parts of the polymer matrix, more preferentially of between 0.5 and 5 parts per hundred parts of the polymer matrix. Use may be made, as (primary or secondary) accelerator, of any compound capable of acting as accelerator for the vulcanization of diene polymers, particularly diene elastomers, in the presence of sulfur, especially accelerators of thiazole type, and also their derivatives, and accelerators of thiuram and zinc dithiocarbamate types. Preferably, use is made of a primary accelerator of the sulfenamide type.

When the chemical crosslinking is carried out using one or more peroxide compounds, said peroxide compound or compounds represent from 0.01 to 10 parts per hundred parts of the polymer matrix. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The composite in accordance with the invention may also include all or part of the usual additives habitually dispersed in polymer matrices containing a diene polymer, particularly an elastomer. A person skilled in the art selects the additives according to the envisaged application of the composite. For example, for an application of the composite in the tire, in particular as a reinforcing structure or reinforcement in the tire, as additives mention may be made of pigments, protection agents such as anti-ozone waxes, chemical antiozonants, antioxidants, plasticizers or delivery agents.

The first non-productive phase and the productive phase are mechanical working steps, in particular kneading, well known to a person skilled in the art in manufacturing rubber compositions. The first non-productive phase is generally distinguished from the productive phase in that the mechanical work is conducted at high temperature, up to a maximum temperature of between 110° C. and 190° C., preferably between 130° C. and 180° C. The productive phase that follows the non-productive phase, generally after a cooling step, is defined by mechanical working at lower temperature, typically below 110° C., for example between 40° C. and 100° C., during which finishing phase the crosslinking system is incorporated.

The reinforcing filler, the crosslinking system and the additives are generally distributed in the polymer matrix by incorporating them into the polymer matrix before the component is brought into contact with the polymer matrix. For example, the reinforcing filler may be incorporated into the polymer matrix by mechanical mixing, particularly thermomechanical mixing, optionally in the presence of the previously cited additives. The mixing temperature is selected carefully by a person skilled in the art depending on the thermal sensitivity of the polymer matrix, its viscosity and the nature of the reinforcing filler. The crosslinking system is incorporated into the polymer matrix typically at a temperature lower than the temperature at which crosslinking occurs to allow its dispersion in the polymer matrix and later shaping of the composite before the crosslinking of the polymer matrix. Generally, the crosslinking system is incorporated in the polymer matrix after the incorporation of the reinforcing filler and other additives in the polymer matrix.

According to one particularly preferential embodiment, the composite is a reinforced product which comprises reinforcing elements and a calendering rubber in which the reinforcing elements are embedded, each reinforcing element consisting of a component previously defined according to any one of the embodiments of the invention and the calendering rubber comprising the polymer matrix. According to this embodiment, the reinforcing elements are arranged generally side by side in a main direction. The calendering rubber may also contain polymer matrix, a reinforcing filler, a crosslinking system and other additives as previously defined and distributed in the polymer matrix. For an application envisaged in the tire, the composite may thus constitute a tire reinforcement.

The composite in accordance with the invention may be in the raw state (before crosslinking of the polymer matrix) or in the cured state (after crosslinking of the polymer matrix). The composite is cured after the component has been brought into contact with the polymer matrix into which were optionally incorporated a reinforcing filler, a crosslinking system and other additives as described above.

The composite can be manufactured by a process that comprises the following steps:
producing two layers of the polymer matrix in which a reinforcing filler, a crosslinking system and other additives are optionally dispersed,
taking the component sandwiched in the two layers by depositing it between the two layers,
where appropriate, curing the composite.

Alternatively, the composite can be manufactured by depositing the component on a portion of a layer, the layer is then folded over on itself to cover the component which is thus sandwiched over its entire length or a part of its length.

The layers may be produced by calendering. During curing of the composites, the polymer matrix is crosslinked, in particular by vulcanization or by peroxides.

When the composite is intended to be used as a reinforcement in a tire, the curing of the composite generally takes place during the curing of the tire casing.

The tire, also a subject of the invention, has the essential feature of comprising the composite in accordance with the invention. The tire may be in the raw state (before crosslinking of the polymer matrix) or in the cured state (after crosslinking of the polymer matrix). Generally, during the manufacture of the tire, the composite is deposited in the raw state (that is to say before crosslinking of the polymer matrix) in the structure of the tire before the step of curing the tire.

The abovementioned characteristics of the present invention, and also others, will be better understood on reading the following description of several exemplary embodiments of the invention, given by way of illustration and without limitation.

### II. EXEMPLARY EMBODIMENTS

### II.1-Preparation of the Functional Diene Polymers Useful for the Needs of the Invention:

### Proton NMR Analysis:

Proton NMR analysis is used to determine the structure of the products synthesized, in particular the microstructure of the polymers used or synthesized. The content of the phosphonate, phosphonic hemiacid or phosphonic acid group in the functional diene polymer is given in milliequivalents per gram of functional diene polymer (meq/g).

The spectra are acquired on a Bruker 500 MHz spectrometer equipped with a 5 mm BBIz-grad “broad band” probe. The quantitative ¹H NMR experiment uses a simple 30° pulse sequence and a repetition time of 3 seconds between each acquisition. The samples are dissolved in deuterated chloroform (CDCl₃) or deuterated methanol (MeOD).

### Sec Analysis:

Size exclusion chromatography or SEC is used to determine the macrostructure of the polymers. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards and the polymolecularity or polydispersity index (PI=Mw/Mn) can be calculated via a “Moore” calibration.

Preparation of the polymer: there is no specific treatment of the polymer sample before analysis. The latter is simply dissolved in tetrahydrofuran (THF) that contains 1 vol % of diisopropylamine, 1 vol % of triethylamine and 0.1 vol % of distilled water, at a concentration of approximately 1 g/l or in chloroform, at a concentration of approximately 1 g/l. The solution is then filtered through a filter with a porosity of 0.45 μm before injection.

SEC analysis: the apparatus used is a Waters Alliance chromatograph. The elution solvent is tetrahydrofuran+1 vol % of diisopropylamine+1 vol % of triethylamine or chloroform, according to the solvent used for the dissolution of the polymer. The flow rate is 0.7 mL/min, the temperature of the system is 35° C. and the analytical time is 90 min. A set of four Waters columns in series, with commercial names Styragel HMW7, Styragel HMW6E and two Styragel HT6E, is used.

The volume of the solution of the polymer sample injected is 100 The detector is a Waters 2410 differential refractometer and the software for making use of the chromatographic data is the Waters Empower system.

The calculated average molar masses are relative to a calibration curve produced from “PSS Ready Cal-Kit” commercial polystyrene (PS) standards.

11.1.1—by Radical Copolymerization of at Least One 1,3-Diene and One (Meth)Acrylate Bearing the Functional Group and, where Appropriate, Followed by a Monohydrolysis or Dihydrolysis Reaction According to the Following Procedures:

Synthesis of an SBR Polymer Bearing P(O)(OH)₂ Functional Groups: C1:

The C1 polymer is prepared by terpolymerization of styrene, butadiene and dimethyl(methacryloyloxy)methyl phosphonate (MAP), followed by dihydrolysis of the phosphonate functional groups according to the following procedures:

Terpolymerization:

the following fillers are prepared beforehand:

Solution of tert-dodecylmercaptan (RSH) at 0.7 M in styrene: 3.3 ml of sparged RSH and 16.7 ml of styrene are introduced into a 250 ml bottle.

Resorcinol solution at 100 g/l: 20 g of resorcinol in 200 ml of water are introduced into a 250 ml bottle.

225 ml of water are introduced into a 750 ml Steinie bottle. 1.25 g (5 phr) of hexadecyltrimethylammonium chloride (CTAC) and 300 mg (1.2 phr) of K₂S₂O₈ are introduced into a second 750 ml bottle. The two bottles are sparged for 10 min. The water is transferred via a double needle into the second bottle. 320 ul (0.7 eq/K₂S₂O₈) of RSH at 0.7 M in the styrene, 6 ml of MAP, 5.5 ml of styrene and 22 ml of butadiene are introduced into the bottle. The bottle is placed in a bath at 40° C. for 3 h 15 to reach 60% conversion. It is stopped with 2.44 ml of the resorcinol solution at 100 g/l. The polymer is then coagulated with a 1/1 (by volume) acetone/methanol mixture. It is dried overnight in a tray at 60° C. in an oven. The terpolymer is an elastomer of Mn 47 800.

### Dihydrolysis:

In a two-necked round-bottomed flask, dissolve the terpolymer [Styrene/Butadiene/MAP] in chloroform (solids content=13% by weight) and subject to magnetic stirring at ambient temperature. Using a dropping funnel, add bromotriethylsilane (2.5 equivalents per —PO(OMe)₂ functional group), dropwise, under an argon stream. At the end of the addition, remove the argon stream and leave to stir at ambient temperature for 8 hours. At the end of the reaction, allow to return to ambient temperature, then coagulate the terpolymer in methanol. Allow to separate out, then remove the supernatant methanol. The polymer is then dried in the open air, at ambient temperature. The synthesis yield is quantitative.

The final product is an elastomer having the same Mn as the terpolymer before hydrolysis, and its P(O)(OH)₂ functional group content is 1.30 meq/g.

Synthesis of a Polyisoprene Bearing P(O)(OH)(OMe) Functional Groups: C2:

The C2 polymer is prepared by copolymerization of isoprene and of hemihydrolyzed MAP according to the following procedure:

Introduce isoprene (95 mol %/sum of monomers), hemihydrolyzed MAP (5 mol %/sum of monomers), methyl ethyl ketone (MEK) (solids content=45% by weight) and AIBN (1 mol %/sum of monomers) into an (open cover) autoclave reactor. Close the reactor. Subject to mechanical stirring and pass through a stream of argon or of nitrogen by means of the two gas inlet and outlet valves for 5 minutes. Close the valves and place the reactor at 70° C. for 16 hours. At the end of the polymerization, the product is in two forms:
a solid phase, which is the hemihydrolyzed MAP homopolymer;
a liquid phase, which is the [Isoprene/hemihydrolyzed MAP] copolymer.

The liquid phase is separated from the solid phase, and simply evaporated off, since the copolymer does not coagulate in methanol. The synthesis yield is 22%.

The final product is a liquid polymer, the P(O)(OH)(OMe) functional group content thereof is 0.34 meq/g.

Synthesis of a Polyisoprene Bearing P(O)(OH)(OMe) Functional Groups: C3:

The C3 polymer is prepared by copolymerization of isoprene and MAP, followed by monohydrolysis of the phosphonate functional groups according to the following procedures:

Copolymerization:

Introduce isoprene (96 mol %/sum of monomers), MAP (4 mol %/sum of monomers), toluene (solids content=65% by weight) and AIBN (0.5 mol %/sum of monomers) into an (open cover) autoclave reactor. Close the reactor. Subject to mechanical stirring and pass through a stream of argon or of nitrogen by means of the two gas inlet and outlet valves for 5 minutes. Close the valves and place the reactor at 70° C. for 16 hours. At the end of polymerization, coagulate the copolymer in methanol. Allow to separate out, then remove the supernatant methanol. Dissolve the copolymer in THF, then evaporate off the solvent in a rotary evaporator under reduced pressure. The copolymer is a liquid polymer of Mn 6800. The synthesis yield is 20%.

Monohydrolysis:

Introduce the copolymer, NaI (1.5 equivalents per —PO(OMe)₂ functional group) and a 50/50 by weight mixture of acetone/THF (solids content=8% by weight) into a single-necked round-bottomed flask. Place at 50° C. for 20 hours. The monohydrolyzed copolymer in sodium phosphonate form precipitates from the reaction medium (gel). Remove the liquid phase, then add acetone. Leave to stir at 60° C. for 1 hour. Remove the supernatant acetone, then repeat the washing operation in order to totally remove the excess NaI. Dissolve the copolymer in methanol, add amberlite IR-120 resin and leave to stir at ambient temperature for 1 hour in order to convert the sodium phosphonate into phosphonic acid. Remove the amberlite by filtration. Evaporate off the methanol in a rotary evaporator under reduced pressure. The synthesis yield is 85%.

The final product is a liquid polymer having the same Mn as the polymer before hydrolysis, and its P(O)(OH)(OMe) functional group content is 0.73 meq/g.

Synthesis of a Polyisoprene Bearing P(O)(OH)(OMe) Functional Groups: C4:

The C4 polymer is prepared by copolymerization of isoprene and MAP, followed by monohydrolysis of the phosphonate functional groups according to the following procedures:

Copolymerization:

Introduce isoprene (85 mol %/sum of monomers), MAP (15 mol %/sum of monomers), toluene (solids content=60% by weight) and AIBN (1 mol %/sum of monomers) into an (open cover) autoclave reactor. Close the reactor. Subject to mechanical stirring and pass through a stream of argon or of nitrogen by means of the two gas inlet and outlet valves for 5 minutes. Close the valves and place the reactor at 70° C. for 16 hours. At the end of polymerization, coagulate the copolymer in methanol. Allow to separate out, then remove the supernatant methanol. Dissolve the copolymer in THF, then evaporate off the solvent in a rotary evaporator under reduced pressure. The copolymer is a liquid polymer of Mn 12 500. The synthesis yield is 26%.

Monohydrolysis:

Introduce the copolymer, NaI (1.5 equivalents per —PO(OMe)₂ functional group) and acetone (solids content=13% by weight) into a single-necked round-bottomed flask. Place at 50° C. for 20 hours. The monohydrolyzed copolymer in sodium phosphonate form precipitates from the reaction medium (gel). Remove the liquid phase, then add acetone. Leave to stir at 60° C. for 1 hour. Remove the supernatant acetone, then repeat the washing operation in order to totally remove the excess NaI. Dissolve the copolymer in methanol, add amberlite IR-120 resin and leave to stir at ambient temperature for 1 hour in order to convert the sodium phosphonate into phosphonic acid. Remove the amberlite by filtration. Evaporate off the methanol in a rotary evaporator under reduced pressure. The synthesis yield is quantitative.

The final product is a liquid polymer having the same Mn as the polymer before hydrolysis, and its P(O)(OH)(OMe) functional group content is 1.76 meq/g.

### 11.1.2—by Modification of Diene Polymers Bearing a Nucleophilic Group at the Chain End, in the Case in Point α,ω-Dihydroxylated Polybutadienes, by a Compound Bearing Both the Functional Group and an Electrophilic Group,

The Compound being 10-Carboxyldecylphosphonic Acid (Carboxyl C11 Phosphonic Acid:

Introduce the α,ω-dihydroxylated polybutadiene, the Carboxyl C11 Phosphonic Acid (2.1 equivalents per hydroxyl functional group) and the toluene into a single-necked round-bottomed flask. Fit the round-bottomed flask with a Dean Stark apparatus and place at 140° C. for 24 hours. The reaction is autocatalyzed by the phosphonic acid. The water formed over the course of the reaction is removed in the Dean Stark apparatus by formation of an azeotrope with the toluene (shift of the reaction equilibrium).

At the end of the reaction, coagulate the functional polybutadiene in ethanol. Dry the polymer by stoving at 60° C. The polymers M1 to M3, which are liquid polymers, are synthesized according to this procedure.

The Compound being the Acid 10-Carboxyldecylmethylphosphonate (Carboxyl C11 Phosphonic Acid Hemiester):

In a single-necked round-bottomed flask, dissolve 30.0 g of α,ω-dihydroxylated polybutadiene and 5.3 g (2 eq, i.e. 1 eq per —OH functional group) of Carboxyl C11 Phosphonic Acid Hemiester in 170 ml of toluene. Fit the round-bottomed flask with a Dean Stark apparatus and subject to magnetic stirring at 140° C. There is total conversion after 8 h at 140° C. At the end of the reaction, remove the toluene by evaporation under vacuum. The final product M4 is a liquid polymer.

The compound, 10-carboxyldecylmethylphosphonic acid, used in the modification reaction is prepared by monohydrolysis of 10-carboxyldecyldimethylphosphonic acid (Carboxyl C11 Dimethyl Phosphonate) according to the following protocol:

In a single-necked round-bottomed flask, dissolve 17.0 g of Carboxyl C11 Dimethyl Phosphonate in 110 ml of acetone. Add 19.5 g (2.25 eq) of sodium iodide. Subject to magnetic stirring at 50° C. for 16 hours. A white precipitate appears during reaction: it is the Carboxyl C11 Phosphonic Hemiester ME in sodium salt form. At the end of the reaction, filter off the precipitate, then wash it twice with acetone. Suspend the powder in 500 ml of dichloromethane, and add 50 ml of 1M hydrochloric acid, dropwise, in order to convert the sodium phosphonate into phosphonic acid. Leave to stir at ambient temperature for 2 hours, then transfer the mixture into a separating funnel. Wash the chlorinated phase with clear water. Dry over anhydrous sodium sulfate. Filter. Remove the dichloromethane by evaporation under vacuum. The synthesis yield is 60%. The final product is a white waxy powder; its structure is characterized by ¹H NMR.

The α,ω-dihydroxylated polybutadienes used are products sold by Cray Valley. Table 1 indicates the commercial reference of the α,ω-dihydroxylated polybutadiene for the preparation of the functional polymer useful for the needs of the invention.

TABLE 1

| Functional diene | α,ω-dihydroxylated |
|---|---|
| polymer | polybutadiene |
| M1 | Poly Bd R-20 LM |
| M2, M4 | Krasol LBH-P 3000 |
| M3 | Poly Bd R-45 HTLO |

The nature of the functional group of the functional polymers synthesized according to the procedures described above is given in Table 2, as is the functional group content.

TABLE 2

| | Functional diene polymer | | | |
|---|---|---|---|---|
| | M1 | M2 | M3 | M4 |
| functional | P(O)(OH)₂ | P(O)(OH)₂ | P(O)(OH)₂ | P(O)(OH)(OMe) |
| group | | | | |
| (meq/g) | 0.62 | 0.53 | 0.44 | 0.49 |

### II.2-Preparation of the Composites:

The quality of the bonding between the polymer matrix and the component is determined by a test in which the force necessary to extract sections of individual threads having a metallic surface from the crosslinked polymer matrix is measured. For this purpose, composites are prepared in the form of test specimens containing, on the one hand, metallic individual threads as component having a metallic surface and, on the other hand, an elastomer mixture comprising the crosslinked polymer matrix.

For this, the elastomer mixture comprising the polymer matrix is prepared beforehand.

### 11.2.1—Preparation of the Elastomer Mixtures:

The elastomer mixtures prepared differ from one another by virtue of the polymer matrix, because of the microstructure, macrostructure and functional diene polymer content used in the polymer matrix. For all of the elastomer mixtures, the polymer matrix consists of a mixture of natural rubber and functional diene polymer, the functional diene polymer representing 5, 10, 15 or 25% by weight of the polymer matrix according to the examples. The functional diene polymer used in the polymer matrix, and its content, are indicated in Tables 3 to 6.

To prepare the elastomer mixture, a reinforcing filler, a carbon black (N326), a crosslinking system, and a peroxide (dicumyl peroxide) are incorporated into the polymer matrix according to the protocol described hereinafter. The carbon black content is 50 parts per 100 parts of polymer matrix, the peroxide content is 5 parts per 100 parts of polymer matrix.

The natural rubber, the carbon black and the functional diene polymer are introduced successively into an internal mixer (final degree of filling: approximately 70% by volume), where the initial vessel temperature is approximately 60° C. Thermomechanical working is then carried out (non-productive phase) until a maximum “dropping” temperature of approximately 150° C. is reached. The resulting mixture is recovered and cooled and then the crosslinking system is incorporated into the mixture on an external mixer (homofinisher) at 30° C., everything being mixed (productive phase).

### 11.2.2—Preparation of the Test Specimens:

The elastomer mixtures thus prepared are used to prepare a composite in the form of a test specimen, according to the following protocol:

A block of rubber is prepared, consisting of two plates applied to each other before curing. The two plates of the block consist of the same elastomer mixture. It is during the preparation of the block that the individual threads are trapped between the two plates in the raw state, at an equal distance apart and while leaving to protrude, on either side of these plates, an individual thread end having a length sufficient for the subsequent tensile test. The block including the individual threads is then placed in a mould adapted to the targeted test conditions and left to the discretion of a person skilled in the art; by way of example, in the present case, the block is cured at 160° C. for a time varying from 25 min to 60 min according to the composition under a pressure of 5.5 tonnes.

The individual threads are plain (i.e. non-coated) steel or steel coated with brass or bronze. Their diameter is 1.75 mm, apart from bronzed threads for which the diameter is 1.30 mm; the thickness of the brass coating is 200 nm to 1 μm, the thickness of the bronze coating is 50 nm to 0.1 μm.

For each of the test specimens thus prepared, Tables 3 to 6 indicate:
which of the functional diene polymers C1, C2, C3, C4, M1, M2, M3 and M4 was used
the mass fraction of functional diene polymer in the polymer matrix
the metal of the metallic surface of the individual thread.

Each test specimen is referenced by a numeral followed by a lower case letter, for example 1a. One number corresponds to one functional diene polymer. The lower case letter indicates the nature of the metal of the metallic surface of the individual thread: a for brass, b for steel and c for bronze.

The test specimens thus prepared correspond to composites in accordance with the invention.

### II.3-Results:

### Adhesion Test:

On conclusion of the curing, the resulting test specimen consisting of the crosslinked block and individual threads is placed between the jaws of a suitable tensile testing machine in order to make it possible to test each section individually, at a given rate and a given temperature (for example, in the present case, at 100 mm/min and ambient temperature).

The adhesion levels are characterized by measuring the “tearing-out” force for tearing the sections out of the test specimen.

The results are expressed in base 100 relative to a control test specimen that contains individual threads identical in nature to the test specimen tested and that contains an elastomer mixture, the polymer matrix of which consists of natural rubber (in other words the weight fraction of the functional diene polymer in the polymer matrix is 0% in the control test specimen). Except for the absence of functional diene polymer, the test specimen and also the elastomer mixture of which it is made up are prepared in a manner identical, respectively, to the other test specimens and elastomer mixtures.

A value greater than that for the control test specimen, arbitrarily set at 100, indicates an improved result, that is to say, a greater tearing-out force than that for the control test specimen. The values for the tearing-out forces in base 100 resulting from the tests conducted on the test specimens are summarized in Tables 3 to 6, according to the level of functional diene polymer in the polymer matrix and according to the nature of the individual threads.

Presenting values much higher than 100 in the adhesion test, the composites according to the invention exhibit greatly improved tearing-out resistance, both in the case of thread elements made of steel and those made of brass and of bronze, i.e. comprising iron, copper, zinc or tin.

The improved tearing-out resistance is observed for all the matrices regardless of the microstructure and macrostructure of the functional diene polymers. It is observed as soon as 5% by weight of functional diene polymer is introduced.

It is also remarkable to note that the improvement in the performance of the composite is observed in the absence of any sulfurization step, generally necessary in the manufacturing of composites based on diene elastomer and on steel or brass or bronze.

TABLE 3

Test specimen

| | 6a, 6b | 8b |
|---|---|---|
| Weight fraction 5% | M2 | M4 |
| brass | 380 | |
| steel | 2420 | 1340 |

TABLE 4

Test specimen

| | 6a, 6b | 8b |
|---|---|---|
| Weight fraction 15% | M2 | M4 |
| brass | 420 | |
| steel | 2720 | 1700 |

TABLE 5

| | Test specimen | | | | | | |
|---|---|---|---|---|---|---|---|
| | | | | | | 6a, 6b, | |
| | 1b | 2a, 2b | 3a, 3b, 3c | 4a and 4b | 5a, 5b | 6c | 7a, 7b |
| Weight fraction 10% | C1 | C2 | C3 | C4 | M1 | M2 | M3 |
| brass | | 1240 | 640 | 360 | 380 | 880 | 580 |
| steel | 1320 | 2920 | 1880 | 2920 | 2720 | 1880 | 3180 |
| bronze | | | 1040 | | | 1820 | |

TABLE 6

| | Test specimen | | | | | | |
|---|---|---|---|---|---|---|---|
| | 2a, 2b | 3a, 3b | 4a, 4b | 5a, 5b | 6a, 6b | 7a, 7b | 8b |
| Weight fraction 25% | C2 | C3 | C4 | M1 | M2 | M3 | M4 |
| brass | 1920 | 1180 | 500 | | 2020 | 1440 | |
| steel | 4000 | 4200 | 4640 | 2820 | 2200 | 2600 | 2020 |

1. A composite based at least on a component exhibiting a metallic surface and on a polymer matrix comprising a diene elastomer DE and a functional diene polymer, which functional diene polymer is a diene polymer bearing at least one functional group, the functional group being the phosphonic acid functional group, the phosphonic hemiacid functional group, the phosphonic acid diester functional group or a salt of the phosphonic acid or phosphonic hemiacid functional group.

2. A composite according to claim 1, in which all of the component is made of metal.

3. A composite according to claim 1, in which the metallic surface of the component is made of a material which is different from the remainder of the component.

4. A composite according to claim 1, in which the component is made of a metal which is identical to the metal of the metallic surface.

5. A composite according to claim 1, in which the metallic surface comprises iron, copper, zinc, tin, aluminium, cobalt or nickel.

6. A composite according to claim 1, in which the metal of the metallic surface is a metal selected from the group consisting of iron, copper, zinc, tin, aluminium, cobalt, nickel and alloys comprising at least one of these metals.

7. A composite according to claim 1, in which the metal of the metallic surface is iron, copper, tin, zinc or an alloy comprising at least one of these metals.

8. A composite according to claim 1, in which the metal of the metallic surface is steel, brass or bronze.

9. A composite according to claim 8, in which the steel is a carbon steel or a stainless steel.

10. A composite according to claim 1, in which the component has a length at least equal to a millimetre.

11. A composite according to claim 1, in which the component is a thread or a cord.

12. A composite according to claim 1, which composite is a reinforced structure in which the component constitutes a reinforcing element and in which the polymer matrix coats the reinforcing element.

13. A composite according to claim 1, in which the functional diene polymer bears several of the functional groups.

14. A composite according to claim 1, in which the functional group is at the end of a polymer chain of the functional diene polymer.

15. A composite according to claim 1, in which the functional group is on a single end or on each end of a polymer chain of the functional diene polymer.

16. A composite according to claim 1, in which the functional group is pendent and outside ends of a polymer chain of the functional diene polymer.

17. A composite according to claim 1, in which the functional group content in the functional diene polymer is from 0.01 to 3 milliequivalents per gram, meq/g of functional diene polymer.

18. A composite according to claim 1, in which the phosphonic hemiacid functional group and the phosphonic acid diester functional group have respectively the formulae P(O)(OH)(OR) and P(O)(OR)₂, in which R, which may be identical or different, represent an alkyl.

19. A composite according to claim 1, in which the functional diene polymer is selected from the group of polymers consisting of polybutadienes, polyisoprenes, 1,3-butadiene copolymers, isoprene copolymers and mixtures thereof.

20. A composite according to claim 1, in which the diene elastomer DE represents at least 70% by weight of the polymer matrix.

21. A composite according to claim 1, in which the diene elastomer DE is a polyisoprene having more than 90% by weight of 1,4-cis bonding.

22. A composite according to claim 1, in which the diene elastomer DE and the functional diene polymer represent at least 90% by weight of the polymer matrix.

23. A composite according to claim 1, in which the functional diene polymer represents at most 30% by weight of the polymer matrix.

24. A composite according to claim 1, which also comprises a reinforcing filler distributed in the polymer matrix.

25. A composite according to claim 24, in which the reinforcing filler is a carbon black.

26. A composite according to claim 24, in which the reinforcing filler content is within a range of from 20 parts to 80 parts per 100 parts of the polymer matrix.

27. A composite according to claim 1, which also comprises a system for crosslinking the polymer matrix.

28. A composite according to claim 1, which composite is a reinforced product which comprises reinforcing elements and a calendering rubber in which the reinforcing elements are embedded, each reinforcing element consisting of the component and the calendering rubber comprising the polymer matrix.

29. A composite according to claim 28, which composite is a reinforcement for tires.

30. A tire comprising the composite defined in claim 1.
